(19) United States
(12) Patent Application Publication
(10) Pub. No.: US 2002/0138765 A1
(43) Pub. Date: Sep. 26, 2002

(54) System, process and article for conducting authenticated transactions

(75) Inventors: Jayme Matthew Fishman, North Reading, MA (US); Larry Powers, Encinitas, CA (US)

Correspondence Address: PERKINS, SMITH & COHEN LLP, ONE BEACON STREET, 30TH FLOOR, BOSTON, MA, 02108, US

(73) Assignee: PowerFish Inc.

(21) Appl. No.: 10/132,438

(22) Filed: Apr. 25, 2002

Related U.S. Application Data
(63) Continuation-in-part of application No. 09/816,975, filed on Mar. 23, 2001.

(51) Int. Cl. H04L 9/32; G06F 17/60

(52) U.S. Cl. 713/201; 705/67

(57) ABSTRACT

A system, process and articles for authentication of a party in transaction using authentication keys embedded in a portable physical medium in the possession of the party plus a password entered by that party that are compared against a data base by an authentication server, wherein said physical medium integrally includes a second medium contain information uniquely associated with said party.

### CROSS-REFERENCE

This application is a continuation-in-part of, and claims priority for subject matter disclosed in, the application by the same inventors for “System and Process for Conducting Authenticated Transactions Online,” Ser. No. 09/816,975 filed Mar. 22, 2001 and copending herewith.

1. Field of the Invention

The invention relates generally to transactions conducted over a communications network that require authentication of a party to the transaction.

2. Background

There is need in an open communication network such as the Internet to provide authentication of transaction parties for a variety of reasons, including, without limitation, assurance of authorization to access certain information, the establishment of a legal contract between the parties, and assurance of creditworthiness of one of the parties. Systems implemented and proposed to provide authentication with various levels of confidence have focused on payment mechanisms.

In part because financial institution regulations in the United States have afforded some limitation of consumer liability for fraudulent use of credit cards, secure payment systems employing devices such as “smart cards” with embedded microprocessors, that require special readers (and writers), have not enjoyed popularity in the United States. One alternative proposed, for example by NYCE, is the use of a truncated CD (compact disk) cards, cut roughly to the shape and size of a credit card to allow use in conventional desktop and mobile computers and transportation in a wallet. “One-use” tokens of alphanumeric strings may be written on these CD cards, read on a consumer's desktop or mobile computer and transmitted to the issuer of the token for authentication of the token.

This system focuses on the authentication of the token rather than the identity of the holder of the CD card. While this may be adequate for payment systems analogous to the carrying of cash, there are many network transactions that require identification of a party to the transaction to determine authority, age, etc.

Generally identification of a party to a transaction has been performed using passwords or personal identification numbers (PINs) bound to a user name. These pieces of information are susceptible to diversion. In transactions that require high levels of security, such as administration of a certification authority in a digital signature system, smart cards with encrypted keys have been used in conjunction with logging in with a user name and password. This typically done within a certification authority facility and does not address the need for identification. Identification in currently implemented digital signature systems relies on the possession of the transaction party of a “private key” of an asymmetric private-public-key pair. Various schemes including certification and registration authorities are defined using the asymmetric keys under ANSI's X.9 standard. As these keys typically are kept on a desktop or mobile computer, however, the identification really is of a person (or electronic agent) having access to the keys on that computer. Encryption of the keys on the computer with the use of a password to unlock the keys for each transaction remains cumbersome.

Multiple security methods have been combined for different purposes. An example is provided in U.S. Pat. No. 5,485,519, entitled “Enhanced Security for a Secure Token Code,” issued to Weiss, which discloses a method and apparatus for enhancing the security for a private key by combining a PIN or other secret code memorized by the user with a secure token code to generate a meaningless multi-bit sequence stored in the token. This particular method is viewed as too complex for many of the day-to-day transactions that require authentication of the identity of a party.

There is a need for a portable identification device carried by ordinary people (as consumers, employees or non-specialized professionals) that is usable with ordinary computers (such as desktop or notebook computers) that will not be usable if the device is lost or stolen.

### SUMMARY OF THE INVENTION

The instant invention solves this problem by providing encrypted information on a truncated CD card that in some relevant portion is matched against a data base, including information associated with the user to be identified, by an authentication service provider (a “trusted third party”) in response to the transmission to that service provider of information personally known only to the user (“personal code”), such as a password. The CD card may fit in an ordinary wallet and be read on the CD- or DVD-drive of an ordinary desktop or mobile computer, concentrating processing at the service provider and thereby minimizing cost to the user and the user's transaction partner, in turn facilitating broad day-to-day use. Because the encrypted information residing on the CD card and the personal code resident in the mind of the user is transmitted to the service provider in close temporal proximity, there is assurance against diversion of authenticating information.

In one embodiment, the encrypted information on the CD card are “one-use” tokens implemented as unique sequences of alphanumeric characters embedded among other alphanumeric characters, a portion of which is transmitted to the authorization service provider for matching to a user identified by the personal code; these may be applied as unique signatures to transactions or documents memorializing transactions. In another embodiment, the encrypted information is a digital certificate that is transmitted to the service provider for matching. Other security methods may be added easily to improve on the overall security.

### BRIEF DESCRIPTION OF THE DRAWINGS

FIG. 1 shows schematically the system and process of one implementation of the invention.

FIG. 2 shows schematically the system and process of an alternative implementation of the invention.

FIG. 3A shows a truncated CD-R used with the invention.

FIG. 3B shows a truncated CD-R with a photograph used in an alternative embodiment of the invention.

FIG. 3C shows a truncated CD-R with a magnetic stripe used in an alternative embodiment of the invention.

FIG. 3D shows a truncated CD-R with embedded circuitry used in an alternative embodiment of the invention.

FIG. 3E shows a truncated CD-R with embossed code used in an alternative embodiment of the invention.

FIG. 3F. shows a truncated CD-R with an optical bar code used in an alternative embodiment of the invention.

### Detailed Description of Preferred Embodiments

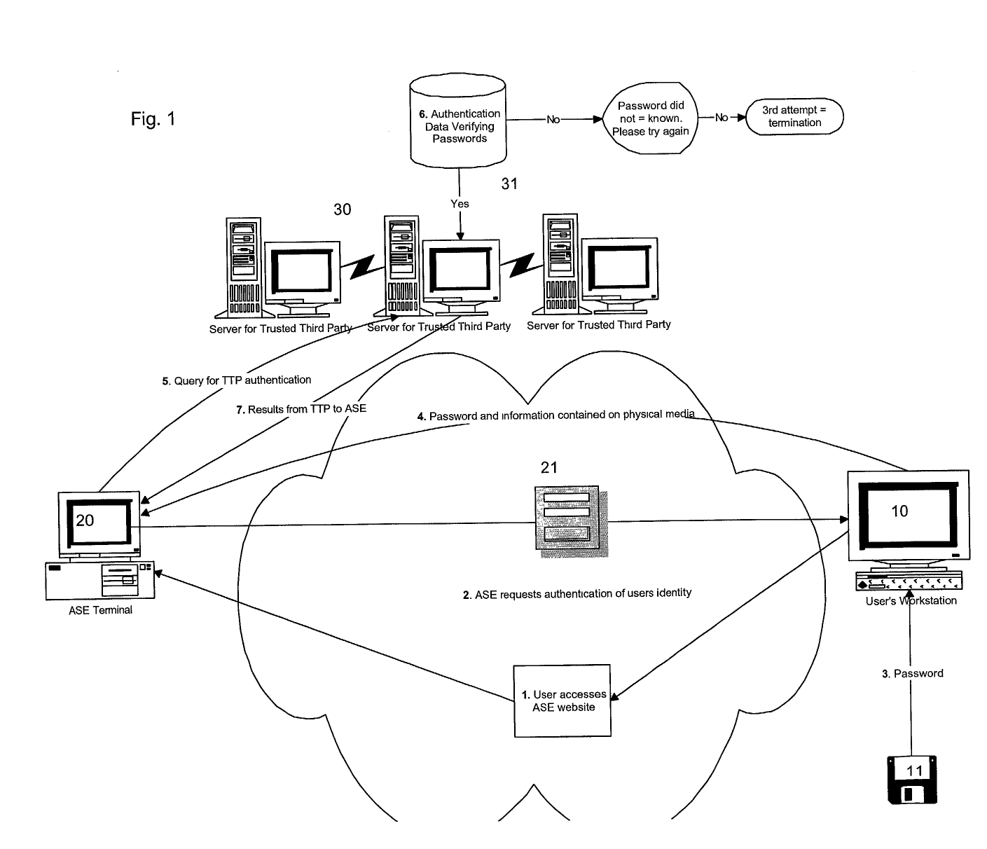

FIG. 1 shows an implementation where the party requiring authentication (authentication-seeking entity or “ASE”) collects both the CD-resident identifying encrypted information and the personal code for transmission to the communicates with the authentication service provider. A user at terminal 10 (which, without limitation, may be a desktop or notebook computer at home, at work or at a point-of-sale-or-service kiosk) accesses 1 the web page 21 of the other transaction party, which may reside on ASE computer 20 (which, without limitation be a desktop, workstation or institutional mainframe computer), which prompts 2 for identification of the user. The user inserts into user terminal 10 CD card 11 with encrypted one-use tokens or a digital certificate (these may be “CD-R cards”, which may be written using ordinary “CD burners”). The user enters password 3 (which may be any personal code known personally only to the user and, for authentication purposes, to the authenticating entity), which is transmitted 4 along with an encrypted token from CD card 11 (the user name or similar identification, known to the ASE, may be transmitted at the same time or may have been provided previously upon logging in). This information is then transmitted by the ASE in a query 5 to trusted third party (TTP) servers 30, one of which may decrypt the CD card information and compares 6 the derived key information for matching on the authenticating entity's preexisting data base with the user password. If there is no match, there may be further prompting and termination of the transaction if the appropriate password is not transmitted. The authentication results are returned 7 to the ASE.

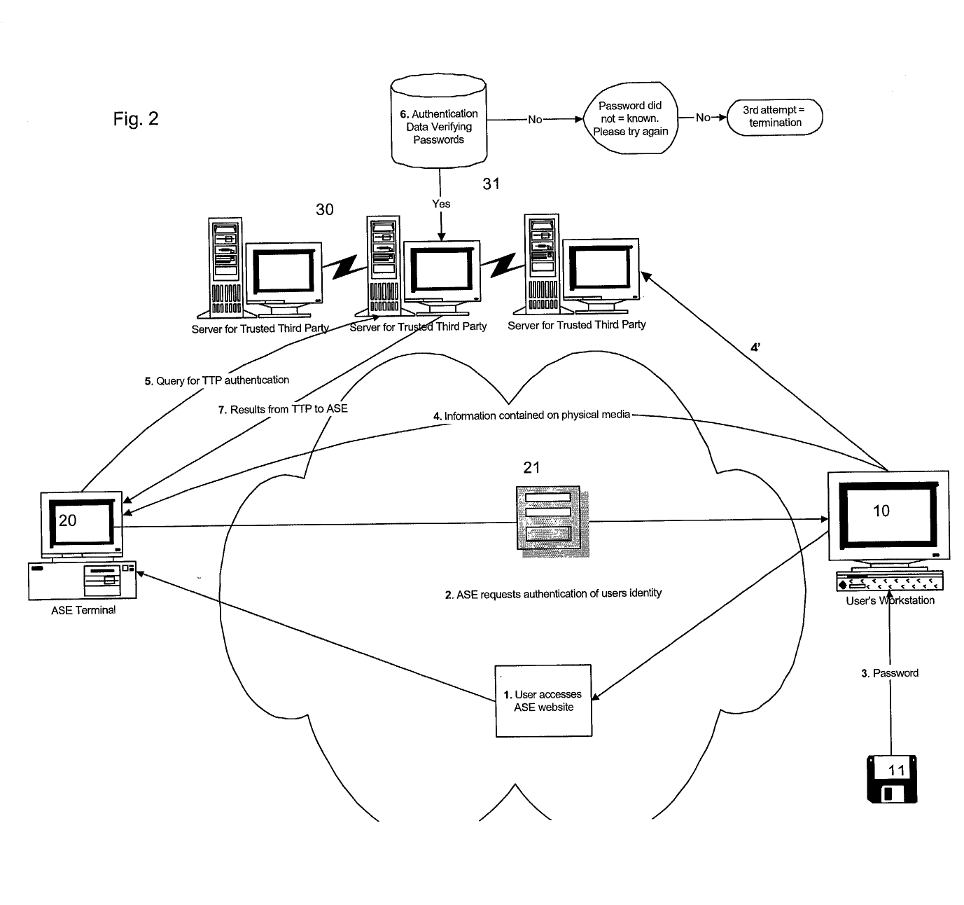

FIG. 2 shows an alternative implementation where the ASE collects only the CD-resident identifying encrypted information, which may serve as a signature, and the personal code is transmitted by the user to the authentication service provider, limiting the possibility of diversion of the personal code by the ASE. A user at terminal 10 accesses 1 the web page 21 of the other transaction party. ASE computer 20 prompts 2 for identification. The user inserts into user terminal 10 CD card 11 with encrypted one-use tokens or a digital certificate. The user then enters the password 3, which is transmitted 4′ to TTP servers 30. An encrypted token from CD card 11 has been or is transmitted 4 to ASE terminal 20 and forwarded in a query 5 to TTP servers 30, which compare 6 the derived key information for matching with the user password. If there is no match, there may be further prompting and termination of the transaction if the appropriate password is not transmitted. The authentication results are returned 7 to the ASE.

In either implementation, the token or digital certificate may serve as a signature associated with the transaction or documentation of the transaction. Records of the transaction with date-stamps may be kept by the authentication service provider with little burden on the user or the ASE.

The system and process may be integrated into desktop applications as plug-in modules or separate application programs. For example, transaction parties may negotiate a contract by exchanging “red-lined” revisions, and upon agreement (or a “milestone” in a “rolling contract” that continues to evolve), one party may invoke the authentication system and process, for example, by clicking a button in a toolbar or printing to the authentication application. The authentication application would prompt for insertion of the party's authentication key, that is, the information (tokens or certificates) resident on the CD card. Once the key is inserted and the user code (password) entered, the party's “signature” is applied; this may simply be a token that can be matched to the user by the authentication service provider (TTP). In this application, each transaction party (and there may be more than two) may act as an ASE for the other transaction parties. Alternatively, there may be no ASE at all, but the authentication service provider or TTP would be a registry for signing or authentication events established by the transmission to it directly (and matching) of the CD-resident information and the personal code, with different possibilities for the TTP's archiving of document- or transaction-identification information, copies of signed documents, unique digital “hashes”, etc.

It should be understood that the authentication service provider (TTP) in each of the embodiments described above may be owned by the same legal entity that owns the ASE and may be on the same local network, as may be the user terminal. Thus, the invention may be usefully applied to identification of users on corporate intranets.

It should also be understood that in each of the embodiments described above, various security/authority levels may be assigned to different authentication keys (tokens or certificates) or personal codes or combinations thereof.

While the embodiments described here rely upon the use of two security devices, namely, unique information resident on a wallet-sized storage device, and unique information personally known only to the user, particular implementations may apply other security devices, or factors, including the user name (such as logging in to an ASE web site), location (such as origination from a node on a particular local network), future biometrics (handwritten signatures, fingerprints, voice, etc.) or combinations of the above to provide even higher levels of assurance of proper authentication.

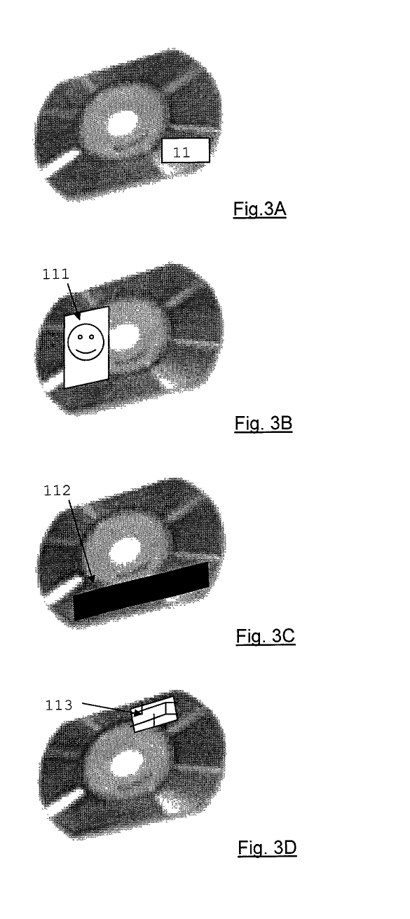

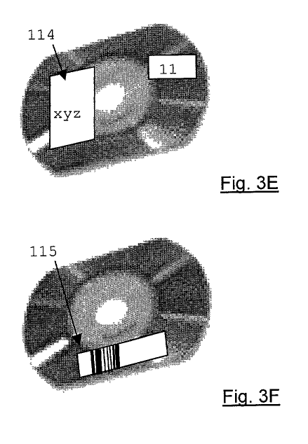

Heretofore unknown enhancements to a truncated CD-R card (which is understood here to include CDs, CD-RWs, and similar optical storage media such as writable DVDs, etc.) may be advantageously used to provide additional security, providing three security devices—four if a user name and password or each counted. FIG. 3A shows a truncated CD-R card 11 that is used in the embodiments previously disclosed.

FIG. 3B shows a truncated CD-R card bearing a photograph 111 of the user, which may be laminated and secured with authenticating tamper-proof lamination. This may be used at a point of transaction authentication/identification to provide additional proof that the bearer of the CD-R card has a proper association with the information resident in the CD-R card that is authenticated according to one of the embodiments previously described.

FIG. 3C shows a truncated CD-R card bearing a magnetic stripe 112. This may be used bear additional information—encrypted or not—that may be read either at a point-of-sale or at a user computer with a magnetic strip reader to provide an additional level of security.

FIG. 3D shows a truncated CD-R with circuitry 113 typical of “smart cards” - which may include programmable memory, with or without a processor—that may respond via an electrical contact (shown) or by electromagnetic (radio) coupling. Used with an appropriate smart card reader either at a point-of-sale or at a user computer, this provides an additional level of security.

FIG. 3E shows a truncated CD-R card bearing an embossed code 114, which may be an identification number. This code may be used for an imprint as in a conventional credit card and may be compared at a point of transaction authentication/identification with code read from the CD-R to provide an additional level of security.

FIG. 3F shows a truncated CD-R with an optically scanned code 115, which may be a bar code. This code may be scanned at the point of transaction authentication/identification with code read from the CD-R to provide an additional level of security.

These five enhanced CD-R's may also be used in transaction authentication or identification systems without a trusted third-party authentication server. Thus, the additional information in the enhancements may be read or scanned either at the owner's computer (equipped with the appropriate scanner) or at a computer at the point of transaction where the enhanced CD-R may be presented for verification of information contained in the CD-R by an authentication server remotely or locally at the point of transaction (part of or connected to the computer), along with verification or comparison of the information in the enhancement.

What is claimed is:

1. A system for authentication of a party in a transaction conducted over a communication network comprising:
a wallet-sized optical storage medium containing information uniquely associated with said party read by a conventional computer operated by said party as part of said transaction, said storage medium integrally including additional information uniquely associated with said party; and
an authentication server remote from said computer that receives said stored information and a personal code entered by said party from said conventional computer as part of said transaction and authenticates said party to said transaction upon matching of said stored information with said personal code based upon information in a preexisting data base.

2. The system of claim I wherein said stored information is transmitted from said conventional computer to said authentication server via a computer of a second party to said transaction.

3. The system of claim 2 wherein said personal code is transmitted from said conventional computer to said authentication server via said computer of said second party.

4. The system of claim 1 wherein said additional information is a photograph of said party.

5. The system of claim 1 wherein said additional information is stored in a magnetic stripe integrated with said optical storage medium.

6. The system of claim 1 wherein said additional information is stored in circuitry integrated with said optical storage medium.

7. The system of claim 1 wherein said additional information is stored in code embossed on said optical storage medium.

8. The system of claim 1 wherein said additional information is stored in scannable optical code imprinted on said optical storage medium.

9. A system for authentication of a party in a transaction comprising:
a wallet-sized optical storage medium containing information uniquely associated with said party read by a conventional computer operated by said party as part of said transaction, said storage medium integrally including additional information uniquely associated with said party; and
an authentication server that receives said stored information and a personal code entered by said party as part of said transaction and authenticates said party to said transaction upon matching of said stored information with said personal code based upon information in a preexisting data base.

10. The system of claim 9 wherein said additional information is a photograph of said party.

11. The system of claim 9 wherein said additional information is stored in a magnetic stripe integrated with said optical storage medium.

12. The system of claim 9 wherein said additional information is stored in circuitry integrated with said optical storage medium.

13. The system of claim 9 wherein said additional information is stored in code embossed on said optical storage medium.

14. The system of claim 9 wherein said additional information is stored in scannable optical code imprinted on said optical storage medium.

15. A process for authentication of a party in a transaction comprising the steps of:
reading by a conventional computer a wallet-sized optical storage medium containing information uniquely associated with said party;
reading additional information uniquely associated with said party stored in a different medium integrated with said optical storage medium;
prompting for and receiving entry by said conventional computer of a personal code of said party; and
matching by an authentication server said information contained in said optical storage medium with said personal code based upon information in a preexisting data base.

16. The process of claim 15 wherein said authentication server is remote from said conventional computer said process further comprising the step of transmitting at least some of said information contained in said optical storage medium from said conventional computer to said authentication server.

17. The process of claim 16 wherein said transmitting step further comprises the step of transmitting said transmitted information from said conventional computer to a computer of a second party to said transaction.

18. The process of Claim 15 wherein said additional information is a photograph of said party and further comprising the step of comparing said photograph with said party at the time of transaction.

19. The process of claim 15 wherein said additional information is stored in a magnetic stripe integrated with said optical storage medium and further comprising the step of verifying said additional information locally with said reading of said information contained in said optical storage medium.

20. The process of claim 15 wherein said additional information is stored in a magnetic stripe integrated with said optical storage medium and further comprising the steps of transmitting said additional information to and verifying it at said authentication server located remotely from said reading of said information contained in said optical storage medium.

21. The process of claim 15 wherein said additional information is stored in a magnetic stripe integrated with said optical storage medium and further comprising the steps of transmitting said additional information to and verifying it remotely from said reading of said information contained in said optical storage medium and from said matching by said authentication server.

22. The process of claim 15 wherein said additional information is stored in circuitry integrated with said optical storage medium and further the step of verifying said additional information locally with said reading of said information contained in said optical storage medium.

23. The process of claim 15 wherein said additional information is stored in circuitry integrated with said optical storage medium and further comprising the steps of transmitting said additional information to and verifying it at said authentication server located remotely from said reading of said information contained in said optical storage medium.

24. The process of claim 15 wherein said additional information is stored in circuitry integrated with said optical storage medium and further comprising the steps of transmitting said additional information to and verifying it remotely from said reading of said information contained in said optical storage medium and from said matching by said authentication server.

25. The process of claim 15 wherein said additional information is provided in code embossed on said optical storage medium and further comprising the step of verifying said additional information locally with said reading of said information contained in said optical storage medium.

26. The process of claim 15 wherein said additional information is provided in code embossed on said optical storage medium and further comprising the steps of transmitting said additional information to and verifying it at said authentication server located remotely from said reading of said information contained in said optical storage medium.

27. The process of claim 15 wherein said additional information is provided in code embossed on said optical storage medium and further comprising the steps of transmitting said additional information to and verifying it remotely from said reading of said information contained in said optical storage medium and from said matching by said authentication server.

28. The process of claim 15 wherein said additional information is provided on an optically scannable code on said optical storage medium and further comprising the step of verifying said additional information locally with said reading of said information contained in said optical storage medium.

29. The process of claim 15 wherein said additional information is provided on an optically scannable code on said optical storage medium and further comprising the steps of transmitting said additional information to and verifying it at said authentication server located remotely from said reading of said information contained in said optical storage medium.

30. The process of claim 15 wherein said additional information is provided on an optically scannable code on said optical storage medium and further comprising the steps of transmitting said additional information to and verifying it remotely from said reading of said information contained in said optical storage medium and from said matching by said authentication server.

31. A wallet-sized optical storage medium containing information uniquely associated with a person, said storage medium integrally including a photograph of said party.

32. A wallet-sized optical storage medium containing information uniquely associated with a party, said storage medium integrally including a magnetic stripe containing additional information uniquely associated with said party.

33. A wallet-sized optical storage medium containing information uniquely associated with a party, said storage medium integrally including circuitry storing additional information uniquely associated with said party.

34. A wallet-sized optical storage medium containing information uniquely associated with a party, said storage medium embossed with additional information uniquely associated with said party.

35. A wallet-sized optical storage medium containing information uniquely associated with a party, said storage medium integrally including optically scannable additional information uniquely associated with said party.
